(19) United States
(12) Patent Application Publication
(10) Pub. No.: US 2023/0296761 A1
(43) Pub. Date: Sep. 21, 2023

(54) IMAGE GENERATION DEVICE, IMAGE GENERATION METHOD, AND PROGRAM

(71) Applicants: NIPPO CO., LTD., Kawasaki-shi, Kanagawa (JP); SHIMIZU CORPORATION, Tokyo (JP)

(72) Inventors: Mikio SATOMURA, Kawasaki-shi (JP); Hirokazu ITO, Kawasaki-shi (JP); Shinichi UEDA, Kawasaki-shi (JP); Mikio SUENO, Ushiku-shi (JP); Tomohiro NARUMI, Tokyo (JP); Norihiro YAMAGUCHI, Tokyo (JP)

(21) Appl. No.: 18/019,142

(22) PCT Filed: Aug. 4, 2021
(86) PCT No.: PCT/JP2021/029008

§ 371 Date: Feb. 1, 2023

(30) Foreign Application Priority Data
Aug. 4, 2020 (JP) 2020-132381

(51) Int. Cl. G01S 13/90

(52) U.S. Cl. CPC G01S 13/9023

(57) ABSTRACT

The present image generation device includes an acquisition unit that acquires an interference SAR (synthetic aperture radar) image relating to an earth ground surface of a predetermined range and generated based on a plurality of SAR images generated by reflecting radio waves received from a SAR satellite by a reflecting plate disposed at a predetermined point, a bird's-eye view image relating to the earth ground surface, and ground point data including coordinates of the predetermined point on the earth ground; and an image generation unit that specifies the predetermined point in the bird's-eye view image based on the ground point data, and generates an integrated image by combining the predetermined point specified in the interference SAR image, the interference SAR image and the bird's-eye view image with a reference of the predetermined point.

### TECHNICAL FIELD

The present disclosure relates to an image generation device, an image generation method, and a program.

This application claims priority on Japanese Patent Application No. 2020-132381 filed Aug. 4, 2020, the contents of the Japanese Patent Application are incorporated herewith.

### BACKGROUND ART

For the coordinates of the ground surface, the dynamic coordinate management including time changes due to the crustal movements is required. In Patent Document 1, a technology of calculating the coordinates of a displacement point on a map at a predetermined date and time of an arbitrary positioning point that fluctuates based on the crustal movement. On the other hand, a technology in which a flying object such as an artificial satellite transmits electromagnetic waves such as microwaves and millimeter waves to the earth ground surface and makes the reflected waves to interfere with the data received by the flying object so as to acquire the crustal movement of an arbitrary point on the entire surface of the earth ground range is known. In Patent Document 2, a technology of associating the positional information acquired by the positioning device with a SAR (synthetic aperture radar) interference image as an aspect of a satellite image is disclosed image.

### CITATION LIST

### Patent Document

### [Patent Document 1]

Japanese Patent (Granted) Publication No. 6528293

### [Patent Document 2]

Japanese Patent (Granted) Publication No. 6555522

### SUMMARY OF INVENTION

### Technical Problem

With the related technology as described above, there is a case in which it may be difficult to accurately grasp the coordinates of an arbitrary point and the state of the crustal movement on the entire surface of a predetermined earth ground range, and to provide a satisfactory bird's-eye view image. In other words, there is a need for visualizing the time variation of the crustal movement at an arbitrary point on the entire surface of a predetermined earth ground range so as to grasp the time variation of the crustal movement with a high precision easily.

The present disclosure has been made in view of such circumstances, and a purpose there of is to provide an image generation device, an image generation method, and a program for generating an image capable of visualizing the time variation of the crustal movement at an arbitrary point on the entire surface of a predetermined earth ground range.

### Solution to Problem

According to a first aspect of the present disclosure, an image generation device includes an acquisition unit that acquires an interference SAR (synthetic aperture radar) image relating to an earth ground surface of a predetermined range and generated based on a plurality of SAR images generated by reflecting radio waves received from a SAR satellite by a reflecting plate disposed at a predetermined point, a bird's-eye view image relating to the earth ground surface, and ground point data including coordinates of the predetermined point on the earth ground; and an image generation unit that specifies the predetermined point in the bird's-eye view image based on the ground point data, and generates an integrated image by combining the predetermined point specified in the interference SAR image, the interference SAR image and the bird's-eye view image with a reference of the predetermined point.

According to a second aspect of the present disclosure, an image generation method includes acquiring an interference SAR (synthetic aperture radar) image relating to an earth ground surface of a predetermined range by reflecting radio waves received from a SAR satellite by a reflecting plate disposed at a predetermined point; acquiring a bird's-eye view image relating to the earth ground surface; acquiring ground point data including coordinates of the predetermined point on the earth ground; specifying the predetermined point in the bird's-eye view image based on the ground point data, and generating an integrated image by combining the interference SAR image and the bird's-eye view image with a reference of the predetermined point.

According to a third aspect of the present disclosure, a program causes a computer to function as a means of using an interference SAR (synthetic aperture radar) image relating to an earth ground surface of a predetermined range by reflecting radio waves received from a SAR satellite by a reflecting plate disposed at a predetermined point, a bird's-eye view image relating to the earth ground surface, and ground point data including coordinates of the predetermined point on the earth ground to specify the predetermined point in the bird's-eye view image based on the ground point data, and generate an integrated image by combining the interference SAR image and the bird's-eye view image with a reference of the predetermined point.

### Advantageous Effects of Invention

According to each of the above-mentioned aspects, the situation of the crustal movement can be easily grasped with a high precision by generating an image capable of visualizing the time change of the crustal movement at an arbitrary point on the entire surface of the predetermined earth ground range.

### BRIEF DESCRIPTION OF DRAWINGS

FIG. 1 is a view showing a configuration of an image generation system according to a first embodiment.

FIG. 2 is a view showing a hardware configuration of an image generation device according to the present embodiment.

FIG. 3 is a functional block diagram showing the image generation device according to the present embodiment.

FIG. 4 is a view showing a processing flow of the image generation device according to the present embodiment.

FIG. 5 is a view showing an overview processing for identifying an association relationship between the interference SAR image and the bird's-eye view image according to the present embodiment.

FIG. 6 is a view showing an image of a system for acquiring an integrated image including the bird's-eye view image and the variation amount thereof according to the present embodiment.

FIG. 7 is a view showing a minimum configuration of the image generation device according to the present embodiment.

FIG. 8 is a view showing a processing flow of the image generation device with the minimum configuration according to the present embodiment.

### DESCRIPTION OF EMBODIMENTS

Hereinafter, an image generation device according to a first embodiment of the present disclosure will be described with reference to the drawings.

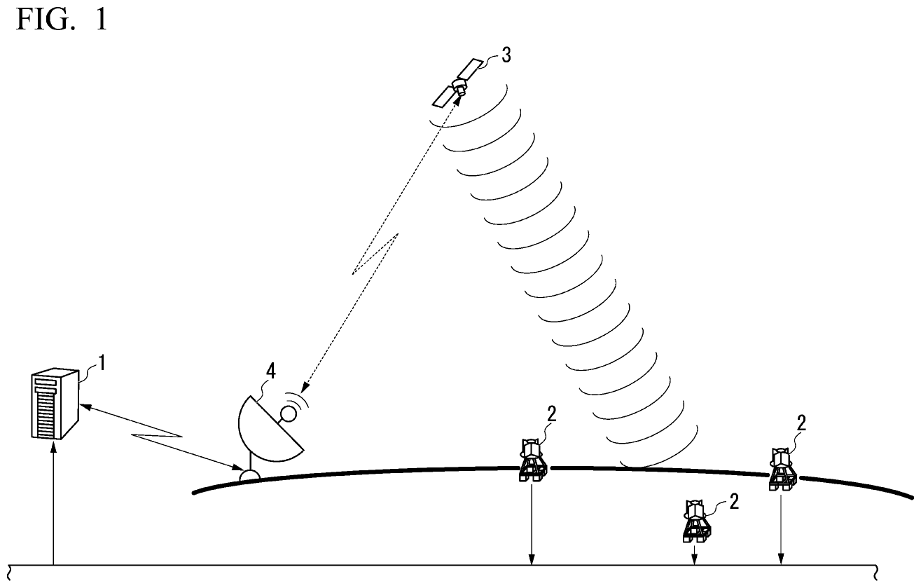

FIG. 1 is a view showing a configuration of an image generation system according to the first embodiment.

As shown in FIG. 1, the image generation system 100 includes an image generation device 1, a reflector 2, and a SAR satellite 3. The image generation device 1 is an example of an information processing device. A manager installs the reflector 2, which is an example of the object, on the earth ground surface. The reflector 2 is an example of a positioning device including at least a reflecting plate and a position sensor. The reflecting plate is configured to reflect microwave or millimeter-wave electromagnetic waves received from the SAR satellite 3 (flying object) equipped with a SAR (synthetic aperture radar). The position sensor is configured to receive satellite positioning signals received from a plurality of GNSS (Global Navigation Satellite System) satellites and calculate the coordinates in which the reflector 2 is installed. A plurality of the reflectors 2 are installed at desired positions on the earth ground surface and ground objects (buildings and other structures). The reflector 2 is configured to transmit the calculated coordinates of the own device, the ID of the own device, and the positional information (ground point data) at least including the calculating time of the coordinates to the image generation device 1 connected to a communication network or the like at predetermined intervals.

The SAR satellite 3 receives the reflected wave of the electromagnetic wave in the wavelength band other than the visible light transmitted by the SAR toward the ground surface by the SAR. The SAR satellite 3 generates a SAR image (synthetic aperture radar image) based on the reflected wave data received by the SAR, and transmits the SAR image data showing the SAR image to the satellite antenna 4 installed on the earth ground surface. The SAR image is an example of a photographed image.

The satellite antenna 4 transmits the SAR image data to the image generation device 1. The SAR satellite 3 may transmit the received data of the reflected wave of the electromagnetic wave to the satellite antenna 4, the satellite antenna 4 may transfer the data to the image generation device 1, and the image generation device 1 may generate the SAR image based on the received data.

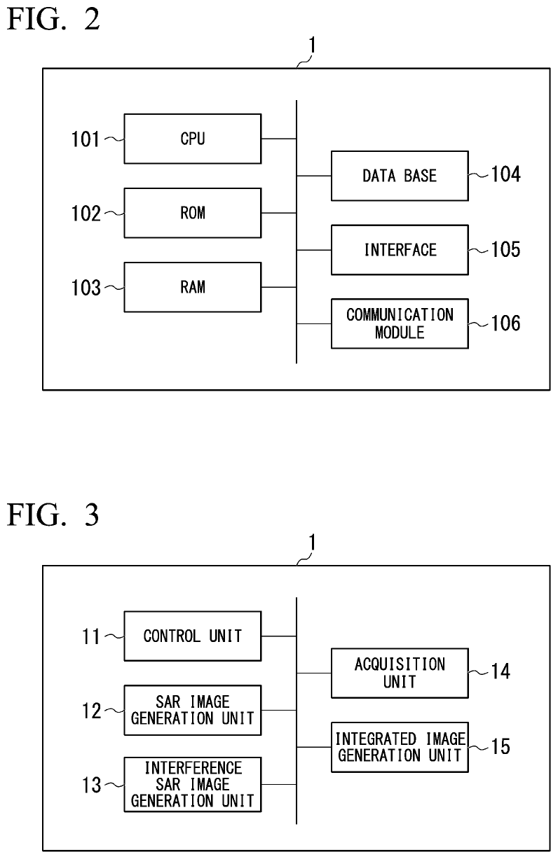

FIG. 2 is a view showing a hardware configuration of the image generation device 1.

As shown in FIG. 2, the computer of the image generation device 1 includes a CPU (Central Processing Unit) 101, a ROM (Read Only Memory) 102, a RAM (Random Access Memory) 103, a database 104, an interface 105, a communication module 106, and the like.

FIG. 3 is a functional block diagram of the image generation device 1.

The CPU 101 of the image generation device 1 executes an image generation program. As a result, the image generation device 1 exerts the functions of the control unit 11, a SAR image generation unit 12, an interference SAR image generation unit 13, an acquisition unit 14, and an integrated image generation unit 15.

The control unit 11 controls each function of the image generation device 1.

The SAR image generation unit 12 generates a SAR image in a predetermined range on the earth ground surface.

The interference SAR image generation unit 13 generates an interference SAR image based on a plurality of SAR images generated at different times with respect to the earth ground surface in the predetermined range.

The acquisition unit 14 acquires at least the interference SAR image, a bird's-eye view image of the earth ground surface in the predetermined range, and ground point data including coordinate data and displacement data of a predetermined point on the earth ground surface in the predetermined range. The interference SAR images is generated based on plurality of SAR images of the earth ground surface in the predetermined range.

The integrated image generation unit 15 generates the integrated image in which the interference SAR image, the bird's-eye view image, and the ground point data are combined based on the predetermined point shown in the interference SAR image, the predetermined point shown by the bird's-eye view image, and the ground point data.

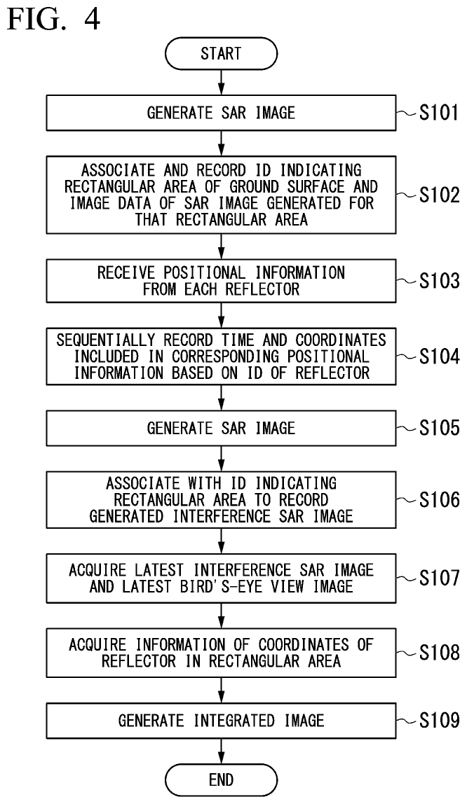

FIG. 4 is a view showing a processing flow of the image generation device 1.

Hereinafter, the details of the processing of the image generation device 1 will be described.

The SAR image generation unit 12 of the image generation device 1 generates the SAR image based on the data received from the SAR satellite 3 via the satellite antenna 4 (Step S101). The SAR image may be generated by a conventional method. As an example, the SAR image generation unit 12 generates the SAR images for each predetermined rectangular range set on the earth ground surface based on the data received from the SAR satellite 3. The SAR image generation unit 12 associates an ID indicating the rectangular range of the earth ground surface, positional information indicating the rectangular range of the image (for example, coordinates of each vertex of the rectangular range), and image data of the SAR image generated for the rectangular range and then records them in the database 104 (Step S102).

It is assumed that a plurality of reflectors 2 are installed in advance in the range of the earth ground surface shown by the SAR image. Accordingly, the shining positions where the brightness is high based on the reception of the electromagnetic wave such as the microwave or the millimeter wave reflected by reflecting plate of the reflector 2 are included in the SAR image. In the SAR image, the shining positions where the brightness is high indicate the positions corresponding to the coordinates of the reflector 2.

The SAR image generation unit 12 repeatedly generates the SAR image of each rectangular range while gradually shifting the rectangular range set on the earth ground surface as the SAR satellite 3 moves. Also, the SAR image generation unit 12 receives the data transmitted by the SAR satellite 3 via the satellite antenna 4 each time when the relative positional relationship due to the movement of the SAR satellite 3 and the rotation of the earth becomes the same and sequentially generates the SAR image of the same rectangular range at the same position. As a result, the database 104 sequentially stores the SAR images of each rectangular range set by shifting on the earth ground surface and generated at different times.

The database 104 of the image generation device 1 stores the bird's-eye view image for each rectangular range in advance in association with the ID indicating the rectangular range on the earth ground surface. The bird's-eye view image is, for example, an aerial photograph image or a map image. The aerial photographic image may be a satellite image or an aerial photographic image for each rectangular area of the earth ground surface. The map image may be a three-dimensional map image, a two-dimensional map image, or the like. The bird's-eye view image may be updated at predetermined time intervals and the latest bird's-eye view image may be recorded in the database 104. The position or a mark of the reflector 2 may be attached to the bird's-eye view image.

The image generation device 1 receives the positional information from each of the plurality of reflectors 2 (Step S103). The image generation device 1 sequentially records the time and coordinates included in the positional information in the database 104 based on the ID of the reflector 2 included in the positional information (Step S104).

In the image generation device 1, the interference SAR image generation unit 13 acquires the plurality of SAR images generated by photographing at different times registered in the database 104 in association with the ID indicating the rectangular range. The interference SAR image generation unit 13 generates the interference SAR image using the plurality of SAR images (Step S105). The interference SAR image generation unit 13 records the generated interference SAR image in the database 104 in association with the ID indicating the rectangular range (Step S106).

The SAR image is, for example, an image represented by shading according to the gradation from white to black. The SAR image is an image in which a position where the reflected radio wave reflected on the earth ground surface is strong is bright (the gradation value is large) and a position where the reflected radio wave is weak is dark (the gradation value is small). On the other hand, the interference SAR image is an image generated by interfering two SAR images generated by photographing at different times. The interference SAR image is, for example, an image having information on the phase difference of each radio wave of the two SAR images as a first SAR image and a second SAR image obtained by photographing the same rectangular area.

For example, a situation of generating the SAR image based on the received light information of the reflected wave from the earth ground surface of a radio wave having a wavelength of 10 cm is assumed. At this time, it is assumed that at a specific place on the earth ground surface, after the first SAR image is generated by the first photographing, the crustal movement occurs in which the ground surface approaches the SAR satellite by 2 cm, and then the second SAR is captured at the same position. In this case, the radio wave output by the SAR satellite 3 at the time of the second autographing is reflected on the earth ground surface and returns to the SAR satellite 3 again. The distance between the positions where the crustal movement occurred when the second SAR image is captured and the SAR satellite 3 is 4 cm shorter than the distance between the position where the crustal movement does not occur when the first SAR image is captured and the SAR satellite 3. When the radio waves of the first SAR image and the second SAR image are interfered with each other, the reflected wave at the position where the crustal movement occurred is received by the SAR satellite 3 4 cm earlier than the wavelength of 10 cm such that a difference in phase by 0.4 wavelength occurs compared with the position where the crustal movement does not occur. The interference SAR image is an image that visualizes the distribution of this phase difference. The process of generating the interference SAR image is a conventional known technology.

The interference SAR image is, for example, retains the movement amount toward the SAR satellite direction in each pixel for leading to the movement amount and movement direction vector of the up-down component and east-west component due to the crustal movement from the signal obtained from the SAR satellite that moves north and south in the space above the earth ground. When the SAR satellite moves in a direction other than north-south direction, each pixel of the interference SAR image may retain the movement amount toward the SAR satellite direction for leading to the movement amount and movement direction vector of the up-down component and the south-north component in the direction orthogonal to the movement direction due to the crustal movement. The interference SAR image may be an image retaining the movement toward the SAR satellite direction per each pixel for leading to the movement amount and movement direction vector of the up-down component, the east-west component, and the north-south component due to the crustal movement in either direction as the result of combining the movement amount and the movement direction vector of the vertical component and the horizontal component due to the crustal movement.

In the data base 104 due to the above-described processing, the information such as the SAR image, the SAR interference image, and the coordinates of the reflector 2 is recorded therein. In such a state, the control unit 11 of the image generation device 1 instructs the integrated image generation unit 15 to generate the integrated image. At this time, the control unit 11 outputs the ID indicating the rectangular range of the target for generating the integrated image to the integrated image generation unit 15. The integrated image generation unit 15 acquires the latest interference SAR image recorded in the database 104 in association with the ID of the rectangular range and the latest bird's-eye view image (Step S107). The integrated image generation unit 15 acquires the coordinates indicating the rectangular range stored in advance in the database 104 or the like with respect to the ID indicating the target rectangular range, and the coordinates of the reflectors 2 in the rectangular range specified based on those coordinates (Step S108). It is assumed that three or more reflectors 2 are installed in the target rectangular range.

The integrated image generation unit 15 specifies the position of the reflector 2 in each of the interference SAR image and the bird's-eye view image in the target rectangular range. The integrated image generation unit 15 may specify, for example, a pixel having a predetermined brightness or higher due to the reflection of the electromagnetic wave by the reflector as the position of the reflector 2 in each of the interference SAR image and the bird's-eye view image. When the mark of the reflector 2 and other information are attached to each of the interference SAR image and the bird's-eye view image, the integrated image generation unit 15 may specify the position of the reflector 2 in each of the interference SAR image and the bird's-eye view image based on the information. The integrated image generation unit 15 may acquire instruction information in which the position of the reflector 2 is instructed by a user operation in each of the interference SAR image and the bird's-eye view image.

The integrated image generation unit 15 adds the interference SAR image to the bird's-eye view image by combining the coordinates of the plurality of reflectors 2 within the target rectangular range with the coordinates of the plurality of reflectors 2 included in each of the interference SAR image and the bird's-eye view image, and further generates the integrated image including the information of the coordinates of the reflector 2 corresponding to the pixel at the position of the reflector 2 (Step S109). When the rectangular range shown by the interference SAR image or the rectangular range shown by the bird's-eye view image is distorted, the integrated image generation unit 15 may correct the distortion by using a known distortion correction technology, and then combine these images by aligning positions based on the coordinates of the reflector 2 to generate the integrated image. As the distortion correction technique, an affine transformation technology or a Helmert transformation technology may be used.

The integrated image generation unit 15 may calculate the coordinates of the position in the rectangular range of the earth ground surface corresponding to each pixel of the integrated image, and generate the integrated image retaining the coordinates as the information corresponding to each pixel of the integrated image. In this case, the integrated image generation unit 15 calculates the coordinates of the earth ground surface corresponding to the pixels as the coordinate calculation targets by the interpolation calculation based on the relationship between the positions of the pixels indicating the three or more reflectors 2 and the coordinates thereof, and the positions of the pixels of the coordinate calculation targets in the integrated image. The integrated image generation unit 15 sequentially specifies all the pixels other than the pixels indicating the reflectors 2 in the integrated image as the pixels as the coordinate calculation targets, and sequentially calculates the coordinates of the earth ground surface corresponding to the pixels as the coordinate calculation targets. As a result, the integrated image generation unit 15 can calculate the coordinates of the earth ground surface corresponding to each pixel of the integrated image, and can generate the integrated image retaining the information of the coordinates of the earth ground surface corresponding to each pixel of the integrated image. The position indicating the reflector 2 may be indicated by a plurality of pixels, or a group of a plurality of pixels may be calculated as a value of the same coordinates, and the integrated image retaining the information of those coordinates may be generated.

By the above-described processing, the integrated image generation unit 15 can generate the integrated image in which all of the coordinates of the reflector 2 included in the rectangular range of the integrated image and the coordinates of the position of each pixel in the integrated image other than the point indicating the reflector 2 and the pixels are retained, and the movement amount toward the SAR satellite direction for leading to the movement amount, the movement direction vector, and the movement velocity per unit time or in a predetermined period of the crustal movement at each of these coordinates based on the interference SAR image are retained. As a result, the integrated image in which not only the coordinates of the position where the positioning device such as the reflector 2 or the like is installed and the movement amount and movement direction vector of the coordinates, but also the coordinates of each position of the entire surface in the rectangular range of the target earth ground surface, the movement amount, the movement direction vector, and the movement velocity at the coordinates can be visually grasped. If the bird's-eye view image used to generate the integrated image is the aerial photograph or the map image, it is possible to accurately grasp where and how much the crustal movement occurred.

The integrated image generation unit 15 may calculate the coordinates, the movement amount, and the movement direction vector at each point at the point or in a part of range corresponding to any one or a plurality of pixels other than the pixels corresponding to the positions of the reflectors 2 in the integrated image and generates the integrated image retaining such information.

In the above-described processing, the interference SAR image and the bird's-eye view image registered in the database 104 are acquired in association with the ID indicating the rectangular range of the earth ground surface corresponding to the integrated image, and the coordinates of the reflector 2 included in the rectangular range is specified. Here, at the time of specifying the interference SAR image and the bird's-eye view image showing the same reflector 2 in the rectangular range, the specification may be performed by the following processing.

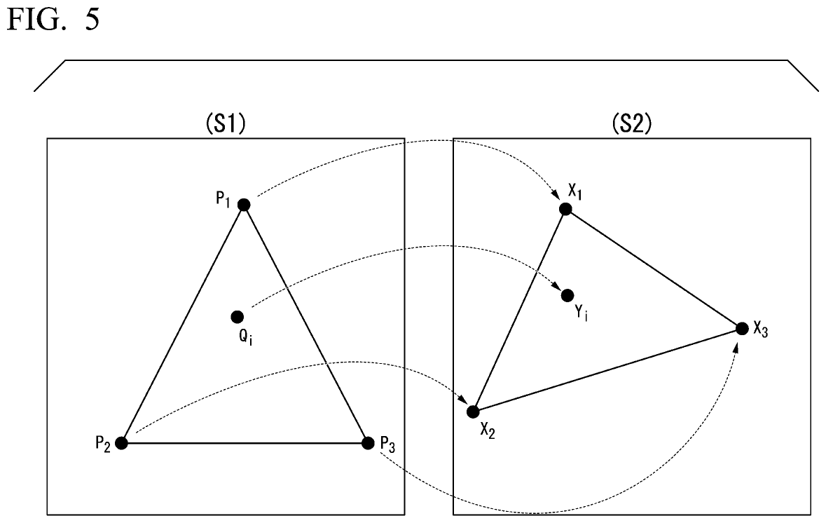

FIG. 5 is a view showing an overview processing for specifying the correspondence relationship between the interference SAR image and the bird's-eye view image.

Hereinafter, the details of the processing for specifying the bird's-eye view image S2 corresponding to the rectangular range from the database 104 based on the coordinates Pᵢ of the reflector 2 shown in the latest interference SAR image S1 will be described. In this processing, the integrated image generation unit 15 defines the point group position Xᵢ indicating the coordinate groups of the plurality of reflectors 2 shown in the bird's-eye view image S2 by Math 1.

[Math 1]

Xᵢ=(xᵢyᵢzᵢ)^{T} (1)

In the above-mentioned Math 1, x indicates the latitude, y indicates the longitude, and z indicates the altitude. Also, i indicates the number of the calculation target point. The integrated image generation unit 15 defines the point group position Pᵢ of the coordinates of the plurality of reflectors 2 specified in the latest interference SAR image S1 by Math 2.

[Math 2]

Pᵢ=(pᵢqᵢrᵢ)^{T} (2)

In Math 2, p indicates the latitude, q indicates the longitude, and r indicates the altitude. Here, the homogeneous transformation matrix T including the rotation, enlargement, reduction and parallel displacement is defined by Math 3.

$$T = ( \begin{matrix}{t}_{11} & {t}_{12} & {t}_{13} & {t}_{14} \\ {t}_{21} & {t}_{22} & {t}_{23} & {t}_{24} \\ {t}_{31} & {t}_{32} & {t}_{33} & {t}_{34} \\ 0 & 0 & 0 & 1\end{matrix} ) \qquad ( 3 )$$

The point group positions indicating the earth ground surface coordinate groups of the plurality of reflectors 2 in the bird's-eye view image S2 are defined based on Xᵢ by Math 4.

[Math 4]

X′ᵢ=(Xᵢ^{T}1)^{T} (4)

Math 4 is a modification equation of Math 1 in order to express the mathematical equation concisely for the convenience of calculation. The point group positions of the earth ground surface coordinates of the plurality of calculation target points specified in the latest interference SAR image S1 are defined based on Pᵢ by Math 5.

[Math 5]

P′ᵢ=(Pᵢ^{T}1)^{T} (5)

Math 5 is a modification equation of Math 2 in order to express the mathematical equation concisely for convenience in calculation. The matrix X\hat{ } representing the point group N of the plurality of reflectors 2 in the bird's-eye view image S2 is represented by Math 6. The matrix P\hat{ } representing the point group N of the plurality of reflectors 2 specified in the latest interference SAR image S1 is represented by Math 7.

[Math 6]

\hat{X}=(X′₁. . . X′_{N}) (6)

[Math 7]

\hat{P}=(P′₁. . . P′_{N}) (7)

The conversion between the point group N of the earth ground surface coordinates of the plurality of reflectors 2 specified in the latest interference SAR image S1 and the point group N of the plurality of reflectors 2 in the bird's-eye view image S2 is represented by Math 8.

[Math 8]

\hat{X}=T\hat{P} (8)

Accordingly, the integrated image generation unit 15 identifies the image data of the bird's-eye view image S2 from the plurality of bird's-eye view images recorded in the database 104. The bird's-eye view image S2 includes the point group position Xᵢ indicating the earth ground surface coordinate group in which Math 9 representing the next homogeneous transformation matrix T is minimized. The integrated image generation unit 15 acquires the specified bird's-eye view image S2 from the database 104. The integrated image generation unit 15 specifies the pixels at the positions from the specified bird's-eye view image S2 corresponding to the coordinates of the reflectors 2 specified in the latest interference SAR image S1 as the coordinates of the reflector 2.

[Math 9]

T=(\hat{P}^{T}\hat{P})⁻¹\hat{P}^{T}\hat{X} (9)

The integrated image generation unit 15 can specify the correspondence between the interference SAR image S1 and the bird's-eye view image S2 including the positions of the reflectors 2 included in an arbitrary rectangular range among the coordinates of the reflectors 2 acquired thereby. The integrated image generation unit 15 may specify the bird's-eye view image S2 including the coordinates based on the coordinates of the reflector 2, and may specify the interference SAR image S1 corresponding to the bird's-eye view image S2 similarly to the above-described processing. The integrated image generation unit 15 may generate an integrated image in which the interference SAR image S1 and the bird's-eye view image S2 identified in this manner, and further the reflectors 2 included in the rectangular range thereof are integrated.

The coordinates of the reflectors 2 acquired by the above-described processing may be a transformation value acquired due to a four-dimensional integrated network average calculation with the coordinates of the positions other than the reflectors 2.

The integrated image generation unit 15 calculates the transformation value of transforming the coordinates of the reflectors 2 and the estimated value of the movement velocity using the four-dimensional integrated network average calculation based on the acquired coordinates and the movement velocity per unit time of the reflectors 2, the coordinates and the movement velocity per unit time of the IGS (International GNSS Service; international geodetic observation) observation point, and other one or more of the coordinates of one or more different artificial satellites, manned aircraft, or unmanned aircraft. The four-dimensional integrated network average calculation is a calculation method of an integrated network average performed by using the four-dimensional information of three-dimensional coordinates and velocity. The four-dimensional integrated network average calculation equation is an equation expressed by the Math 10.

[Math 10]

V+AX+GS=1 (10)

In Math 10, the vector V indicates the residual, the vector X indicates the coordinates of the unknown positioning point, and the vector S indicates the change rate (movement velocity) of the coordinates of the unknown point. In Math 10, 1 (the lower case of L) is the observation value (the length of the baseline connecting the coordinates of the known positioning point and the IGS observation point, and the vector thereof), A is the design matrix, and G is the coefficient matrix. The positioning point is the point of the reflector 2. Then, when Math 10 is solved by the least squares collocation, Math 11 and Math 12 are obtained.

[Math 11]

(A^{t}M⁻¹A)X=A^{t}M⁻¹1 (11)

[Math 12]

M=GKG^{t}+Σ (12)

The estimated values X\hat{ }, S\hat{ }, V\hat{ } (\hat{ } represent the estimated value) of X, S, and V can be calculated by Math 13, Math 14, and Math 15.

$$[ Math 13 ]$$

$$\hat{X} = {( {A}^{t} {M}^{- 1} A )}^{- 1} {A}^{t} {M}^{- 1} 1 \qquad ( 13 )$$

$$[ Math 14 ]$$

$$\hat{S} = {KG}^{t} M ( 1 - A \hat{X} ) \qquad ( 14 )$$

$$[ Math 15 ]$$

$$\hat{V} = 1 - [ \begin{matrix}A & G\end{matrix} ] [ \begin{matrix}\hat{X} \\ \hat{S}\end{matrix} ] \qquad ( 15 )$$

According to the above-described processing, the integrated image generation unit 15 calculates the transformation value of the coordinates of the reflectors 2 by using the four-dimensional integrated network average calculation based on the coordinates and the movement velocity per unit time of the reflectors 2, the coordinates and the movement velocity per unit time of the IGS observation point, and other one or more of the coordinates of one or more artificial satellites, manned aircraft, or unmanned aircraft. Accordingly, it is possible for the image generation device 1 to calculate the transformation value of the coordinates of the earth ground surface corresponding to the positions of the reflector 2 shown in the interference SAR image and the bird's-eye view image and the estimated values of the movement velocity thereof with a high precision. The integrated image generation unit 15 may calculate the coordinates corresponding to the other pixels by using the transformation values and the movement velocity of the coordinates calculated for the reflectors 2 and similarly using the four-dimensional integrated network average calculation. The integrated image generation unit 15 may generate the integrated image in which the coordinates calculated by these processes and the information of the movement velocity are retained in each coordinate.

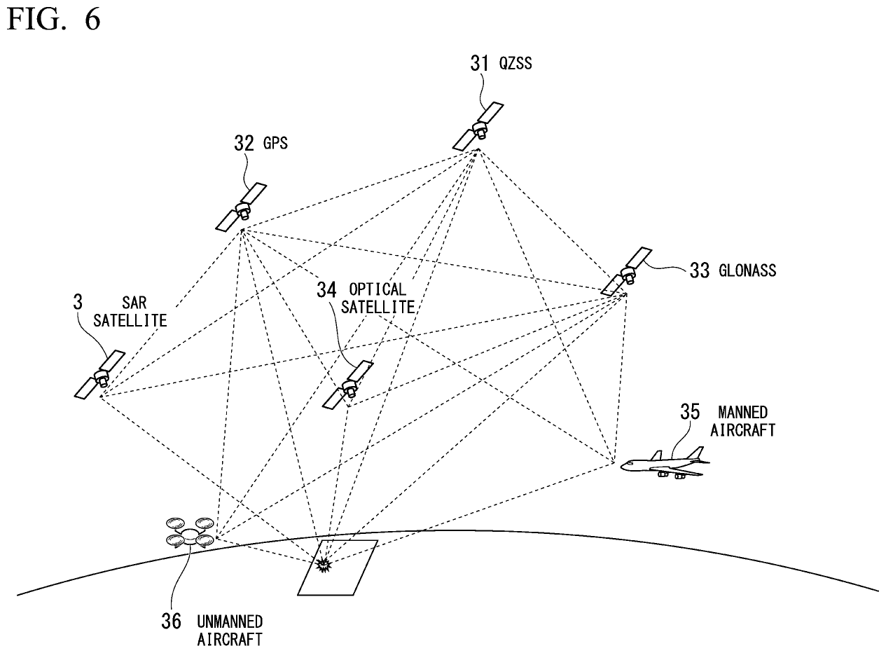

FIG. 6 is a diagram showing an image of a system for obtaining the bird's-eye view image and the integrated image including the variation amount thereof.

As shown in FIG. 6, the image generation device 1 acquires the data by photographing a SAR satellite 3, another artificial satellite such as QZSS (Quasi-Zenith Satellite System) 31, GPS (Global Positioning System) 32, and GLONASS (Global Navigation Satellite System) 33, an optical satellite 34, a manned aircraft 35, and an unmanned aircraft 36 (drone or the like) to generate the integrated image.

The bird's-eye view images to be integrated into the integrated image may be, for example, aerial photographs and map images of runways, aerial photographs and map images of construction sites, aerial photographs and map images of laid roads, aerial photographs of mountain areas, and aerial photographs and map images of forest management areas. Based on the bird's-eye view image generated using such aerial photographs and map images, it is easy to grasp the coordinates, the amount of movement, the movement direction vector, and the movement velocity of each position on the entire surface of the runway, the coordinates, the amount of movement, the movement direction vector, and the movement velocity of each position of the construction sites, the coordinates, the amount of movement, the movement direction vector, and the movement velocity of each position of the laid roads, the coordinates, the amount of movement, the movement direction vector, and the movement velocity of each position of the mountain areas, and the coordinates, the amount of movement, the movement direction vector, and the movement velocity of each position of the forest management areas.

When the map image is a map image of a tropical rainforest, information such as the transformation values of earth ground surface coordinates, the movement amount (crustal movement amount), the movement direction vector, and the movement velocity is included in each pixel of the map image of the tropical rainforest. By creating such map images of tropical rainforest at predetermined intervals and comparing them with each other, it is possible to monitor the forest disappearance due to the burnt fields, the logging situations, and the growth status of trees of the artificial tree planting forests due to the difference in the information of the images at the same position with a high precision.

When the map image is a map image including the roads, information such as the transformation values of earth ground surface coordinates, the movement amount (crustal movement amount), the movement direction vector, and the movement velocity is included in each pixel of the map image including the roads. By creating such map images of roads at predetermined intervals and comparing them with each other, it is possible to grasp what kind of deviation occurs in the position of the roads due to the influence of the crustal movement caused by an earthquake or the like. When a moving object such as a vehicle automatically travels using such a map image, the latest positional information with a high precision can be obtained from the information stored in each pixel of the map.

When the map image is a map image including the runway, information such as the transformation values of earth ground surface coordinates, the movement amount (crustal movement amount), the movement direction vector, and the movement velocity is included in each pixel of the map image including the runway. By creating such map images of roads at predetermined intervals and comparing them with each other, it is possible to grasp what kind of deviation occurs in the position of the runway of the airport due to the influence of the crustal movement caused by an earthquake or the like. In a case in which an aerial floating body such as a drone or an aircraft automatically travels using such a map image, the latest positional information with a high precision can be obtained from the information stored in each pixel of the map.

When the map image is a map image including a railway line, information such as the transformation values of earth ground surface coordinates, the movement amount (crustal movement amount), the movement direction vector, and the movement velocity is included in each pixel of the map image including the a railway line. By creating such map images of railway line at predetermined intervals and comparing them with each other, it is possible to grasp what kind of deviation occurs in the position of the railway line under construction due to the influence of the crustal movement caused by an earthquake or the like. By identifying the position directly above the tunnel center of the tunnel with the map image, it is possible to monitor the ground of the tunnel.

When the map image is a map image including a construction site, information such as the transformation values of earth ground surface coordinates, the movement amount (crustal movement amount), the movement direction vector, and the movement velocity is included in each pixel of the map image including the construction site. By creating such map images of construction site at predetermined intervals and comparing them with each other, it is possible to perform the management of work progress for checking the progress at each point during the construction period at the construction site, and monitor the aged deterioration after the completion of the construction.

When the map image is a map image including a mountainous area, information such as the transformation values of earth ground surface coordinates, the movement amount (crustal movement amount), the movement direction vector, and the movement velocity is included in each pixel of the map image including the mountainous area. By creating such map images of mountainous area at predetermined intervals and comparing them with each other, it is possible to monitor crustal movements, mountain expansion such as volcanoes, and landslides. Similarly, it is possible to monitor the embankment ground in a predetermined area and monitor the sedimentation of artificial islands.

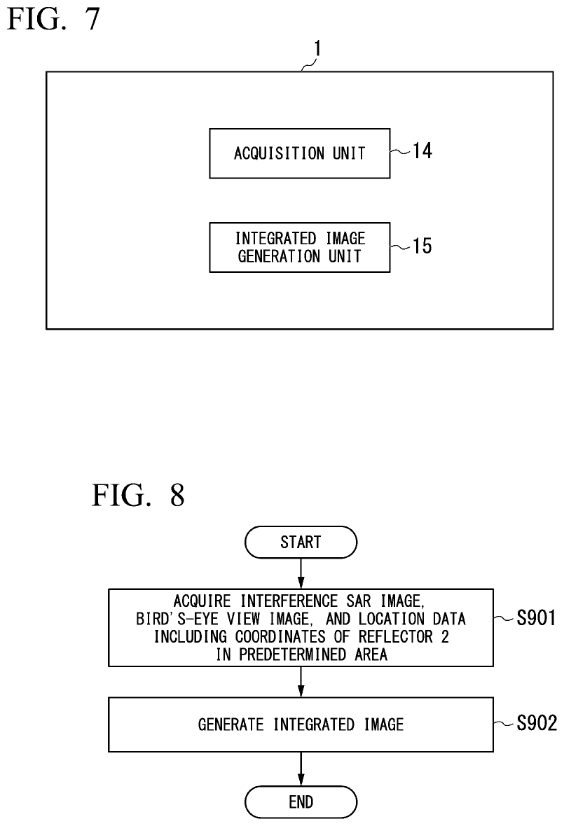

FIG. 7 is a view showing the minimum configuration of the image generation device 1. FIG. 8 is a view showing a processing flow by the image generation device 1 having the minimum configuration. The image generation device 1 only has to be configured to have at least the functions of the acquisition unit 14 and the integrated image generation unit 15.

The acquisition unit 14 acquires the interference SAR image generated based on the plurality of SAR (synthetic aperture radar) images of the predetermined range of the earth ground surface, acquires the bird's-eye view image of the predetermined range of the earth ground surface, and obtains the ground point data including the coordinates of the predetermined point on the earth ground in the predetermined range (Step S901).

The integrated image generation unit 15 generates the integrated image in which the interference SAR image, the bird's-eye view image, and the ground point data are combined based on the predetermined point specified in the interference SAR image, the predetermined point specified in the bird's-eye view image, and the ground point data. (Step S902).

The above-mentioned image generation device 1 has a computer system inside thereof. The process of each processing described above is stored in a computer-readable recording medium in the form of a program, and the above-described processing is performed by the computer reading and executing this program. Here, the computer-readable recording medium refers to a magnetic disk, a magneto-optical disk, a CD-ROM, a DVD-ROM, a semiconductor memory, or the like. Also, this computer program may be distributed to a computer via a communication line, and the computer receiving the distribution may be configured to execute the program.

The above-described program may be the feature for realizing a part of the above-mentioned functions. Furthermore, a so-called differential file (differential program) may be used, which can realize the above-mentioned function in combination with a program already recorded in the computer system.

As described above, the embodiment of the present disclosure has been described in detail with reference to the drawings; however, the specific configuration is not limited to the embodiment, and the design and the like within a range not deviating from the scope of the present invention are also included. The present disclosure is not limited by the above description, but only by the appended claims.

### INDUSTRIAL APPLICABILITY

According to each of the above-described embodiments, it is possible to provide an image generation device, an image generation method, and a program that can visualize the time variation of the crustal movement at an arbitrary point on the entire surface of a predetermined earth ground range.

### REFERENCE SIGNS LIST

1 image generation device
2 reflector
3 SAR satellite
4 satellite antenna
11 control unit
12 SAR image generation unit
13 interference SAR image generation unit
14 acquisition unit
15 integrated image generation unit

1-10. (canceled)

11. An image generation device, comprising:
an acquisition unit that acquires an interference SAR (synthetic aperture radar) image relating to an earth ground surface of a predetermined range and generated based on a plurality of SAR images generated by reflecting radio waves received from a SAR satellite by a reflecting plate disposed at a predetermined point, a bird's-eye view image relating to the earth ground surface, and ground point data including coordinates of the predetermined point on the earth ground; and
an image generation unit that specifies the predetermined point in the bird's-eye view image based on the ground point data, and generates an integrated image by combining the predetermined point specified in the interference SAR image, the interference SAR image and the bird's-eye view image with a reference of the predetermined point.

12. The image generation device according to claim 11, wherein the bird's-eye view image is an aerial photographic image.

13. The image generation device according to claim 11, wherein the bird's-eye view image is a three-dimensional map image or a two-dimensional map image.

14. The image generation device according to claim 11, wherein the predetermined point in the interference SAR image is specified based on brightness.

15. The image generation device according to claim 11, wherein the coordinates corresponding to each pixel of the integrated image except for the predetermined point are further calculated based on the coordinates of the predetermined point and the integrated image retaining the coordinates corresponding to each pixel is generated.

16. An image generation device, comprising:
an acquisition unit that acquires an interference SAR (synthetic aperture radar) image relating to an earth ground surface of a predetermined range and generated based on a plurality of SAR images generated by reflecting radio waves received from a SAR satellite by a reflecting plate disposed at a predetermined point, and a bird's-eye view image relating to the earth ground surface, wherein the reflecting plate has a mark; and
an image generation unit that specifies the predetermined point in the bird's-eye view image based on the mark, and generates an integrated image by combining the predetermined point specified in the interference SAR image, the interference SAR image and the bird's-eye view image with a reference of the predetermined point.

17. The image generation device according to claim 16, wherein the bird's-eye view image is an aerial photographic image.

18. The image generation device according to claim 16, wherein the bird's-eye view image is a three-dimensional map image or a two-dimensional map image.

19. The image generation device according to claim 16, wherein the predetermined point in the interference SAR image is specified based on brightness.

20. The image generation device according to claim 16, wherein the coordinates corresponding to each pixel of the integrated image except for the predetermined point are further calculated based on the coordinates of the predetermined point and the integrated image retaining the coordinates corresponding to each pixel is generated.

21. An image generation method, comprising:
acquiring an interference SAR (synthetic aperture radar) image relating to an earth ground surface of a predetermined range by reflecting radio waves received from a SAR satellite by a reflecting plate disposed at a predetermined point;
acquiring a bird's-eye view image relating to the earth ground surface;
acquiring ground point data including coordinates of the predetermined point on the earth ground; and
specifying the predetermined point in the bird's-eye view image based on the ground point data, and generating an integrated image by combining the interference SAR image and the bird's-eye view image with a reference of the predetermined point.
